(19) United States
(12) Patent Application Publication
(10) Pub. No.: US 2012/0032778 A1
(43) Pub. Date: Feb. 9, 2012

(54) COMMUNICATION SYSTEM AND COMMUNICATION DEVICE

(75) Inventors: Hiroaki Nakano, Tokyo (JP); Isamu Nakao, Tokyo (JP)

(73) Assignee: Sony Corporation, Tokyo (JP)

(21) Appl. No.: 13/193,960

(22) Filed: Jul. 29, 2011

(30) Foreign Application Priority Data
Aug. 6, 2010 (JP) 2010-177529

(51) Int. Cl. G08B 29/00

(52) U.S. Cl. 340/5.52

(57) ABSTRACT

A communication system includes a transmission device configured to transmit a signal on which given biological information is superposed to a human body, and a reception device that receives the signal through the human body, and acquires the given biological information and measures biological information of the human body simultaneously from the signal that is received, so as to perform personal authentication with respect to the human body based on the given biological information that is acquired and the biological information that is measured.

### BACKGROUND

The present technology relates to a communication system and a communication device that perform human body communication. Especially, the present technology relates to a communication system and a communication device that perform biometric authentication through human body communication.

Entry/exit management has been widespread recently. To the management, a non-contact communication technology is mostly applied, and security check is performed by using an IC card such as an employee ID card. However, anybody can pass through such security check using a medium such as a card, as long as he/she has a card even though he/she is not a principal. Thus, anybody can easily impersonate the principal.

On the other hand, in a case of authentication using biological information, only a principal can succeed in authentication, so that the problem of impersonation can be avoided. For example, personal authentication technologies using various biological information such as a fingerprint, an iris, and an electrocardiogram have been proposed.

However, the biological information is personal information, demanding man-hour for the management and bringing a high risk on security as well. An authentication device performing biometric authentication has to hold biological information which is used for comparison and collation with biological information read out from a human body. Further, if the number of people to be authenticated is increased, the authentication device has to handle such large number of personal information and therefore accuracy of biometric authentication is demanded.

For example, an entry/exit management system which is used by 100,000 people is demanded to have accuracy so that the system can reject people other than the 100,000 people in fingerprint authentication or electrocardiographic authentication. Accordingly, biometric authentication has a limitation on the number of people depending on accuracy.

For example, such an authentication system can be considered that a person carries a medium such as a card to which biological information is preliminarily stored and biological information measured from the person on site is compared and collated with the biological information read out from the card in the authentication (refer to Japanese Patent No. 3983993, for example). According to such system, two pieces of information which are the information from the card and the information from the principal are used in the authentication, so that the security is largely improved but there are some problems. For example, an authentication device measures the biological information from the principal after reading out the given biological information from the card, so that the device has to measure the biological information while holding the given biological information which is received in its memory. Such risk is also increased that the given biological information is leaked from the memory. Further, the system performs two processes which are the reading out of the given biological information and the measurement of the biological information from the principal, in series, so that timing to delete the biological information from the system has to be determined. Measurement time of biological information varies between individuals. If the given biological information is kept to be held in the memory during the time from the reading out of the given biological information from the card to the comparison and collation, the security is degraded. If it is set that the given biological information is deleted from the memory when predetermined time (30 seconds, for example) passes after the reception of the given biological information, for example, the security can be maintained but usability is degraded. Further, a path of a signaling system which receives the given biological information from the card and a path of a signaling system which measures the biological information from the principal are different from each other in this system. Therefore, in a case where a large spike noise is superposed on a signal when the given biological information is received or a waveform is distorted due to a surge of a frequency property of a transmission path, data measured from the principal on site is not affected and therefore, the accuracy of the authentication may be degraded.

A method of human body communication to which biometric authentication is combined has been proposed (refer to Japanese Unexamined Patent Application Publication No. 2009-266234, for example). According to this method, one human body communication device transmits protection information along with fingerprint information and the other human body communication device compares a fingerprint acquired on site with the received fingerprint information so as to perform fingerprint authentication. Thus, the information is transmitted through the human body communication, improving the security. However, a signaling system which receives/transmits the fingerprint information and a signaling system which acquires a fingerprint on site are still different from each other. Therefore, the above-described problem still remains. Further, a user of the human body communication device stores his/her biological information (that is, personal information) in a memory of the human body communication device of a communication partner. Thus, there is a risk on the security.

### SUMMARY

It is desirable to provide a superior communication system and a superior communication device that can favorably perform biometric authentication through human body communication while maintaining security and usability of biological information.

According to an embodiment of the present technology, there is provided a communication system including a transmission device configured to transmit a signal on which given biological information is superposed to a human body, and a reception device that receives the signal through the human body, and acquires the given biological information and measures biological information of the human body simultaneously from the signal that is received, so as to perform personal authentication with respect to the human body based on the given biological information that is acquired and the biological information that is measured.

Here, the “system” is an assembly obtained by theoretically assembling a plurality of devices (or functional modules that realize specific functions), and whether respective devices or respective functional modules are in a single case or not does not particularly make any distinction.

A communication device according to another embodiment of the present technology includes a given biological information storage unit configured to store given biological information, a carrier signal generation unit configured to generate a carrier signal, a modulator configured to superpose a given biological information signal that is read out from the given biological information storage unit on the carrier signal, and a transmission unit configured to transmit a modulation signal outputted from the modulator to a human body.

A communication device according to still another embodiment of the present technology includes a reception unit configured to receive a modulation signal obtained by superposing a given biological information signal on a carrier signal, through a human body, a first reception processing unit configured to acquire given biological information from the modulation signal that is received, a second reception processing unit configured to measure biological information of the human body from the modulation signal that is received, and an authentication processing unit configured to perform personal authentication with respect to the human body by collating the given biological information that is acquired by the first reception processing unit with the biological information that is measured by the second reception processing unit.

According to yet another embodiment of the present technology, the second reception processing unit of the communication device of the embodiment described third includes a band-pass filter that extracts a signal component in a frequency band corresponding to the biological information, from the modulation signal that is received.

According to the embodiments of the present technology, a superior communication system and a superior communication device that can favorably perform biometric authentication through human body communication while maintaining security and usability of biological information.

According to the embodiment described first of the present technology, communication of biological information and other information and acquisition of biological information from a principal are simultaneously performed by the human body communication. Therefore, a device which collates the biological information does not have to hold given biological information in a memory and can delete the biological information simultaneously with authentication, being able to realize high security.

According to the embodiment described first, communication of biological information and other information and acquisition of biological information from a principal are simultaneously performed by the human body communication or delay time is constant. Therefore, risk for erroneously detecting the biological information in the measurement is low and thus authentication accuracy is improved.

According to the embodiment described first, a signaling system which transmits/receives given biological information and a signaling system which measures biological information from a principal are common, so that the authentication accuracy, in a case where a noise having no frequency dependency such as a gauss noise is superposed on a propagation path, is improved.

Other purposes, features, and advantages of the embodiment of the present technology will be cleared by later described embodiments of the present technology and detailed descriptions based on accompanying drawings.

### BRIEF DESCRIPTION OF THE DRAWINGS

FIG. 1 schematically illustrates the configuration of a communication system according to an embodiment of the present technology;

FIG. 2 illustrates a comparison between an authentication processing chart of a biometric authentication system of the related art and an authentication processing chart of the communication system of FIG. 1;

FIG. 3 is a flowchart showing a procedure of authentication processing performed by the communication system of FIG. 1; and

FIG. 4 illustrates a state that the communication system is applied to an entry/exit administration system.

### DETAILED DESCRIPTION OF EMBODIMENTS

Embodiments of the present technology will be described in detail below with reference to the accompanying drawings.

A biometric authentication system of the related art has several problems due to difference between a path of a signaling system which receives/transmits biological information and a path of a signaling system which measures biological information from a principal on site, for example, between devices authenticating each other (described above). In contrast, a communication system according to an embodiment of the present technology performs communication of biological information and other information and acquisition of biological information from a principal simultaneously through a single path of a signaling system by human body communication. Therefore, a device which collates the biological information does not have to hold the given biological information in a memory (or a special memory for holding the given biological information does not have to be used).

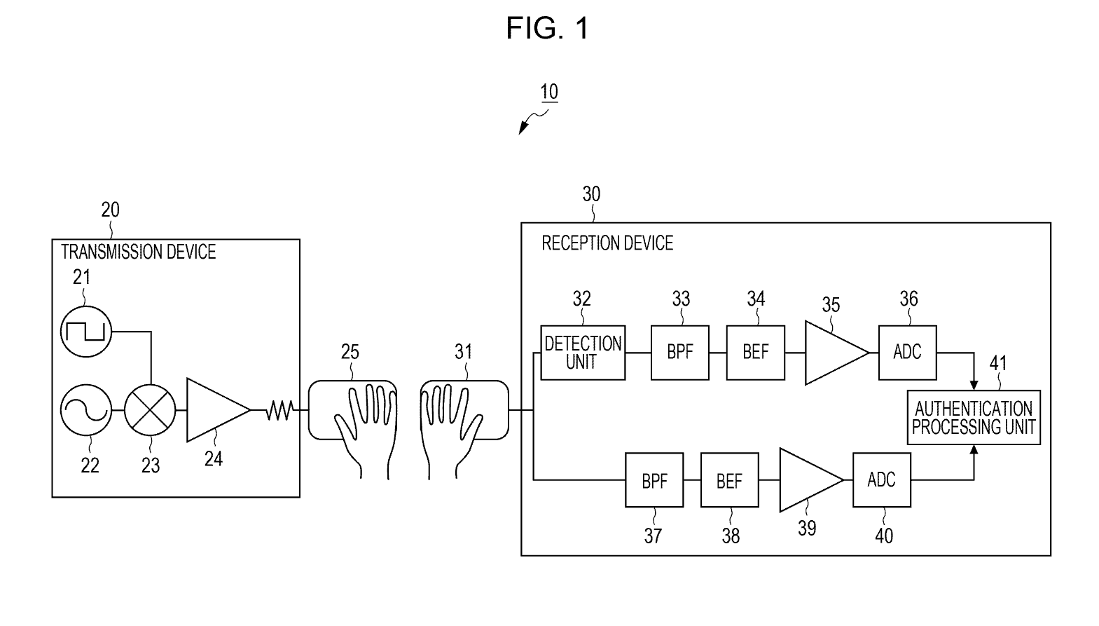

FIG. 1 schematically illustrates the configuration of a communication system 10 according to the embodiment of the present technology. The communication system 10 shown in FIG. 1 is composed of a combination of a transmission device 20 and a reception device 30, and performs human body communication through a human body of a principal who is an authentication object. The transmission device 20 is a device which is carried by a principal who is an authentication object, such as a mobile phone and an ID card (an employee ID card), and receives given biological information. The reception device 30 is a reader which reads data from an ID card, for example. The reception device 30 receives the given biological information from the transmission device 20 and acquires biological information of the principal simultaneously through the human body communication.

The transmission device 20 includes a given biological information storage unit 21, a carrier signal generation unit 22, a modulator 23, a transmission amplifier 24, and a transmission electrode 25.

The given biological information storage unit 21 preliminarily stores biological information of the principal who holds the transmission device 20. A storage method is arbitral. Further, preferable biological information which is handled is biological information which can be acquired through the human body communication (by the reception device 30), and specifically, the biological information is an electrocardiogram or a pulse, for example.

The modulator 23 superposes a given biological information signal read out from the given biological information storage unit 21 on a carrier signal generated in the carrier signal generation unit 22 so as to generate a modulation signal. The transmission amplifier 24 power-amplifies this transmission signal so as to supply the transmission signal to the transmission electrode 25. When the transmission device 20 is carried only by the principal (or some person) and the transmission electrode 25 changes an electromagnetic field near a human body, the modulation signal is sent out to the human body.

On the other hand, the reception device 30 receives information from the change of the electromagnetic field near the human body. The reception device 30 includes a single reception electrode 31 which is shared by a first reception branch which extracts transmitted given biological information from a reception signal and a second reception branch which extracts biological information of a human body which is a communication medium from the reception signal. Alternatively, dedicated reception electrode may be provided for each of the reception branches. However, paths of respective signaling systems can be made more common by using a single reception electrode.

The first reception branch includes a detection unit 32, a first band-pass filter (BPF) 33, a first band-elimination filter (BEF) 34, a first reception amplifier 35, and a first AD converter 36. The detection unit 32 takes out a signal wave component from a modulation wave component included in the reception signal which is received by the reception electrode 31. Then, only a desired frequency band is taken out by the first band-pass filter (BPF) 33, unnecessary frequency band (50 Hz: described later) is eliminated by the first band-elimination filter (BEF) 34, then the signal is amplified by the first reception amplifier 35, and the signal is digital-converted by the first AD converter 36. Thus, an original given biological information signal is reproduced.

The second reception branch includes a second band-pass filter (BPF) 37, a second band-elimination filter (BEF) 38, a second reception amplifier 39, and a second AD converter 40.

The second band-pass filter (BPF) 37 extracts a band necessary for biological information from the reception signal received by the reception electrode 31. The necessary band varies depending on biological information which is handled. Cutoffs of respective reception branches may be same as each other. For example, if an electrocardiogram is used as the biological information, it is preferable to use a band from 1.10 Hz to 35 Hz as a signal component. Accordingly, the second band-pass filter (BPF) 37 is designed to have a property by which a band from 1.10 Hz to 35 Hz becomes flat. That is, the second band-pass filter (BPF) 37 is a low-pass filter (LPF) in a case of an electrocardiogram. For example, refer to Jianchu (Jason) Yao et al. “A Wavelet Method for Biometric Identification Using Wearable ECG Sensors”.

The second band-elimination filter (BEF) 38 is a filter which cuts a certain frequency band and is also called a notch filter. A commercial power source of 50 Hz is largely superposed on a transmission signal in the human body communication, so that the BEF is used for eliminating the 50 Hz (same in the first reception branch).

Then, the reception signal after undergoing the filter processing as described above is amplified by the second reception amplifier 39 and then digital-converted by the second AD converter 40, and thus a biological information signal of the human body which is the communication medium (that is, an authentication object) can be acquired.

An authentication processing unit 41 compares and collates the given biological information signal which is reproduced by the first reception branch with the biological information signal which is acquired by the second reception branch and thus performs personal authentication of the human body which is the communication medium.

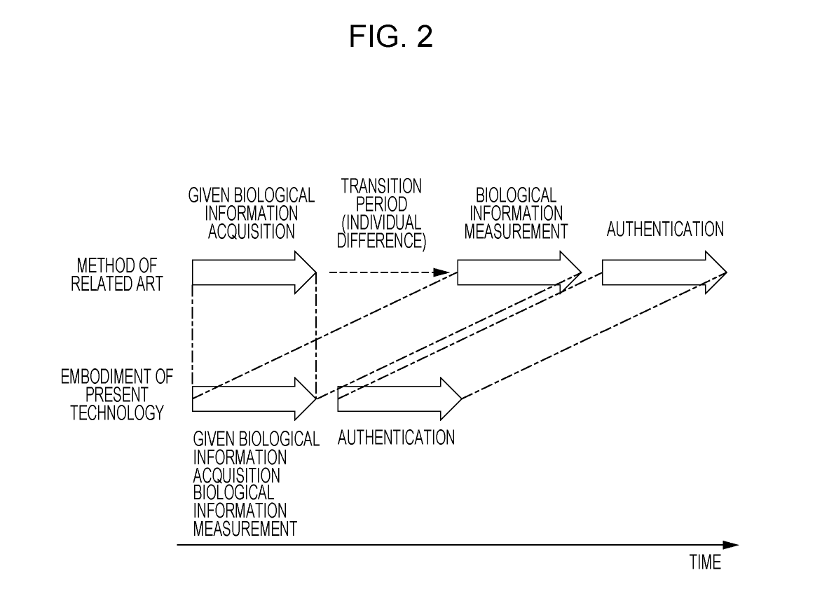

In a biometric authentication system of the related art in which a signaling system which transmits/receives biological information and a signaling system which measures biological information from a principal on site have different paths from each other, a memory for holding given biological information is demanded (described above). In contrast, the communication system 10 shown in FIG. 1 does not use such memory. An authentication processing chart of a biometric authentication system of the related art and an authentication processing chart of the communication system 10 shown in FIG. 1 are compared in FIG. 2. Referring to FIG. 2, it is considered that a memory does not have to be used in the communication system 10.

If a signaling system which transmits/receives given biological information and a signaling system which measures biological information from a principal have different paths from each other, a transition period from transmission of the given biological information to a start of the measurement of the biological information of the principal depends on individuals. Accordingly, the transition period is uncertain. Therefore, it is difficult to fix delay time and a memory for holding a given biological information signal is demanded. Further, time for deleting the given biological information signal from the memory exhibits a trade-off between usability and security. If the given biological information signal is deleted early, security is improved. However, if the measurement of the biological information is not finished by certain time, a user has to repeat the processing from the transmission of the given biological information signal.

Further, a case where a large noise is superposed on a transmission signal during a transition period from the acquisition of the given biological information to the measurement of the biological information causes erroneous detection of a head of the biological information in the measurement. Thus, an authentication error may arise.

On the other hand, in the communication system 10 according to the embodiment of the present technology, a signaling system which transmits/receives given biological information and a signaling system which measures biological information from a principal are common. Therefore, the reception device 30 can simultaneously perform the acquisition of the given biological information and the measurement of the biological information of a user, so that delay caused by individual difference does not exist in these processing. Accordingly, even if circuit delay occurs between the first reception branch and the second reception branch, the value of the circuit delay is constant. Therefore, the delay can be absorbed by the authentication processing unit 41 or can be adjusted by an analog delay device.

Further, the acquisition of the given biological information and the measurement of the biological information are simultaneously performed or the delay time is constant, so that a risk for erroneously detecting the biological information in the measurement is small and authentication accuracy is improved.

Further, the signaling system which transmits/receives the given biological information and the signaling system which measures the biological information from the principal are common, so that the authentication accuracy, in a case where a noise having no frequency dependency such as a gauss noise is superposed on a propagation path, is improved.

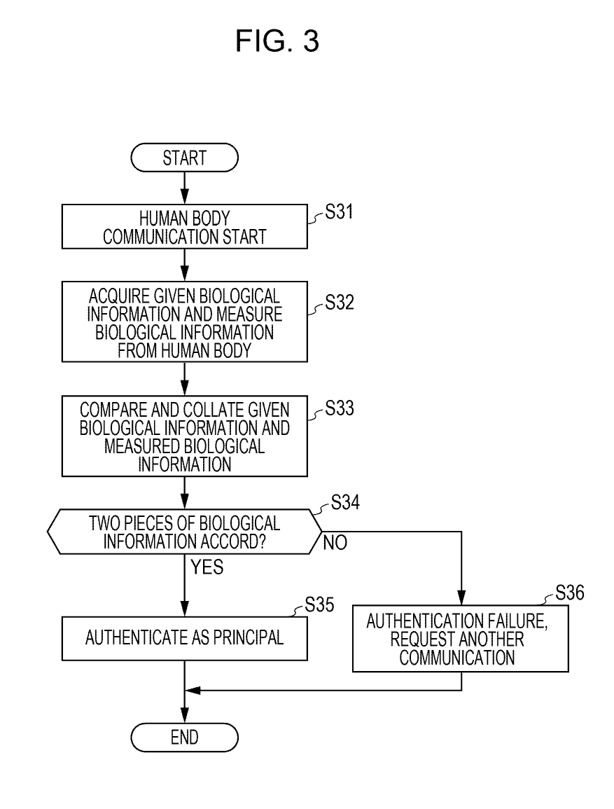

FIG. 3 is a flowchart showing a procedure of the authentication processing performed by the communication system 10 of FIG. 1.

When a user carrying the transmission device 20 which is a mobile phone or an ID card, for example, touches the reception electrode 31 of the reception device 30, human body communication is started (step S31). A modulation signal obtained by superposing a given biological information signal on a carrier signal is transmitted from the transmission electrode 25 of the transmission device 20 through a human body of the user.

In the reception device 30, the first reception branch acquires given biological information and the second reception branch measures biological information of the human body which is a communication medium simultaneously from the reception signal of the reception electrode 31 (step S32).

Then, the authentication processing unit 41 compares and collates these two pieces of biological information (step S33). When the two pieces of biological information accord to each other (Yes of step S34), the user which is the communication medium (that is, who performs an operation for the authentication) is authenticated as a principal (step S35). On the other hand, when the two pieces of biological information do not accord to each other (No of step S34), the authentication processing is failed (step S36). In this case, the communication system 10 may demand the user to repeat the communication or may warn the user.

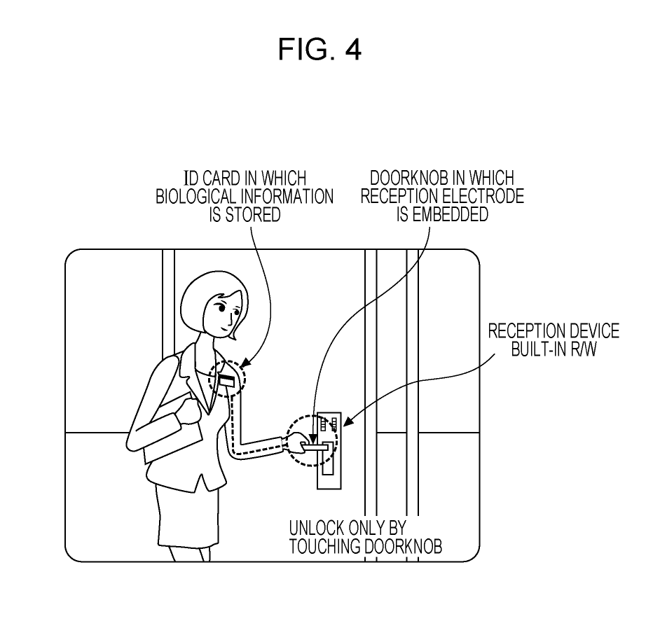

FIG. 4 illustrates a state that the communication system 10 is applied to an entry/exit management system.

In an example shown in FIG. 4, the transmission device 20 is, for example, an ID card such as an employee ID card. Personal biological information such as an electrocardiogram is preliminarily stored in the ID card. A user carries the ID card by putting the ID card in his/her pocket, for example.

On the other hand, the reception device 30 is a card reader (R/W) which reads out information from the ID card. The reception electrode 31 is embedded in a doorknob. When the user carrying the ID card touches the doorknob to enter or leave a room, the reception device 30 can acquire information due to a change of an electromagnetic field existing around the human body, through the reception electrode 31 inside the doorknob and thus the human body communication with the transmission device 20 is started.

A modulation signal obtained by superposing a given biological information signal on a carrier signal is transmitted from the transmission device 20 through the human body of the user. The reception device 30 acquires given biological information from the reception signal and measures biological information from the reception signal passing through the human body of the user who touches the doorknob simultaneously, so as to compare and collate the two pieces of biological information. Thus, the reception device 30 performs the personal authentication. Here, it should be sufficiently understood that entry/exit management with high security and high authentication accuracy can be realized.

Thus, according to the communication system 10 of the embodiment of the present technology, communication of biological information and other information and acquisition of biological information from a principal are simultaneously performed by human body communication. Therefore, the reception device 30 does not have to hold given biological information in a memory and can delete biological information simultaneously with authentication, being able to realize high security.

According to the communication system 10 of the embodiment of the present technology, communication of biological information and other information and acquisition of biological information from a principal are simultaneously performed by human body communication or delay time is constant. Therefore, a risk that the reception device 30 erroneously detects the biological information in the measurement is small and thus authentication accuracy is improved.

According to the communication system 10 of the embodiment of the present technology, the signaling system which transmits/receives given biological information and the signaling system which measures biological information from a principal are common. Therefore, the authentication accuracy, in a case where a noise having no frequency dependency such as a gauss noise is superposed on a propagation path, is improved.

The present disclosure contains subject matter related to that disclosed in Japanese Priority Patent Application JP 2010-177529 filed in the Japan Patent Office on Aug. 6, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A communication system, comprising:
a transmission device configured to transmit a signal on which given biological information is superposed to a human body; and
a reception device that receives the signal through the human body, and acquires the given biological information and measures biological information of the human body simultaneously from the signal that is received, so as to perform personal authentication with respect to the human body based on the given biological information that is acquired and the biological information that is measured.

2. A communication device, comprising:
a given biological information storage unit configured to store given biological information;
a carrier signal generation unit configured to generate a carrier signal;
a modulator configured to superpose a given biological information signal that is read out from the given biological information storage unit on the carrier signal; and
a transmission unit configured to transmit a modulation signal outputted from the modulator to a human body.

3. A communication device, comprising:
a reception unit configured to receive a modulation signal obtained by superposing a given biological information signal on a carrier signal, through a human body;
a first reception processing unit configured to acquire given biological information from the modulation signal that is received;
a second reception processing unit configured to measure biological information of the human body from the modulation signal that is received; and
an authentication processing unit configured to perform personal authentication with respect to the human body by collating the given biological information that is acquired by the first reception processing unit with the biological information that is measured by the second reception processing unit.

4. The communication device according to claim 3, wherein the second reception processing unit includes a band-pass filter that extracts a signal component in a frequency band corresponding to the biological information, from the modulation signal that is received.
